(19) United States
(12) Patent Application Publication
(10) Pub. No.: US 2021/0099624 A1
(43) Pub. Date: Apr. 1, 2021

(54) Intelligent Visual Intercom Doorbell Camera Light

(71) Applicant: Ningbo Fiercer Leopard Electrical Appliance Co., Ltd., Ningbo (CN)

(72) Inventor: Jianqing Cui, Ningbo (CN)

(21) Appl. No.: 16/587,153

(22) Filed: Sep. 30, 2019

(51) Int. Cl. H04N 5/225; F21V 33/00; H04N 7/18

(52) U.S. Cl. CPC H04N 5/2256; F21V 33/0056; F21Y 2115/10; H04N 5/2253; H04N 7/186

(57) ABSTRACT

Disclosed is an intelligent visual intercom doorbell camera light, including a mounting base installed outdoors, a host with a built-in control circuit board, and an auxiliary machine installed indoors. The host is trapezoidal in structure, including a front face and front side faces connecting two side faces. The front face is provided with a camera, a sound receiving hole, a doorbell button, a loudspeaker, and a human body sensor, connected with the control circuit board. Each front side face is provided with a light board. The control circuit board is provided therein with a network communication module capable of transmitting a signal to a mobile phone and the auxiliary machine. Functions of the host are integrated, and the structure design of the host is optimized.

### FIELD OF THE INVENTION

The present disclosure relates to the technical field of illumination, and in particular, to an intelligent visual intercom doorbell camera light.

### BACKGROUND OF THE INVENTION

A doorbell, i.e., a bell on a door, can make a sound to remind the host of a visitor. Now, common doorbells include wireless doorbells and wired doorbells. A traditional wired doorbell system usually includes an outdoor unit and an indoor unit; the indoor unit and the outdoor unit carry out signal transmission and interaction through special cables, and the indoor unit is usually installed in a fixed position of a room, which is extremely inconvenient for installation and maintenance. Most of wired visual doorbell systems use the analog video technology to transmit audio and video signals, and at the same time, in order to save wiring cost and decrease complexity, they generally use the bus technology to share lines for transmitting signals, which has problems such as a poor anti-interference ability, a limited transmission distance and a high cost.

While, the overall function of a wireless doorbell system is not perfect enough, and it brings inconvenience to users. In addition, no matter what kind of doorbell it is, it is relatively independent; and communication is basically limited between the indoor unit and the outdoor unit, and there is little interaction with external devices. With the continuous development of science and technology, the functions of doorbells tend to be diversified.

### SUMMARY OF THE INVENTION

A technical problem to be solved by the present disclosure is to provide an intelligent visual intercom doorbell camera light, which integrates the functions of a host, and optimizes the structure design of the host.

The technical solution adopted by the present disclosure to solve the above-mentioned technical problem is: an intelligent visual intercom doorbell camera light, comprising a mounting base installed outdoors, a host with a built-in control circuit board, and an auxiliary machine installed indoors. The host is a trapezoidal in structure, including a front face and front side faces connecting two sides. The front face is provided with a camera, a sound receiving hole, a doorbell button, a loudspeaker, and a human body sensor, connected with the control circuit board. Each front side face is provided with a light board. The control circuit board is provided therein with a network communication module capable of transmitting a signal to a mobile phone and the auxiliary machine.

According to a further preferred solution of the present disclosure, the host is provided at a top thereof with a notch covered by a dust-proof plug, the notch being provided therein with a memory card connected with the control circuit board. The control circuit board reads a video signal through the camera and inputs the video signal into the memory card for storage; and the control circuit board reads an audio signal through a sound receiving component and inputs the audio signal into the memory card for storage.

According to a further preferred solution of the present disclosure, the host is provided at a bottom thereof with an adjusting knob component connected with the control circuit board, the adjusting knob component being capable of adjusting sensitivity of the human body sensor and a light-emitting duration of the light board.

According to a further preferred solution of the present disclosure, the camera, the sound receiving hole, the doorbell button, the loudspeaker, and the human body sensor are arranged on the front face of the host in an order from top to bottom.

According to a further preferred solution of the present disclosure, the notch is further provided therein with a reset button in communication with the memory card.

According to a further preferred solution of the present disclosure, the mounting base is provided with a spherical notch; the host is connected with the mounting base through a spherical connector installed in the spherical notch, and the spherical notch is surrounded from outside thereof by a locking piece connecting a locking bolt.

According to a further preferred solution of the present disclosure, the mounting base comprises an outer seat provided with a spherical notch and an inner seat connecting a wall, the inner seat and the outer seat being connected through a vertically set sliding chute.

According to a further preferred solution of the present disclosure, the auxiliary machine is provided therein with a control circuit auxiliary board, is provided on a rear face thereof with a plug connecting an insertable socket, and is provided therein with a ringing bell.

According to a further preferred solution of the present disclosure, the auxiliary machine is provided at a front face thereof with an infrared sensor and a plurality of LED lights connected to the control circuit auxiliary board, the plurality of LED lights regularly surrounding the infrared sensor from outside.

According to a further preferred solution of the present disclosure, the control circuit auxiliary board is provided with a network communication module capable of receiving a signal.

Compared with the existing technologies, the advantages of the present disclosure lie in that the host is provided with a camera, a sound receiving hole, a doorbell button, a loudspeaker, a human body sensor, and a light board connected with a control circuit board. Whether there is a visitor or not can be sensed, and the light board emits light at night to illuminate the current environment. When a visitor presses the doorbell button, a signal is transmitted to the mobile phone and the auxiliary machine. Furthermore, the camera will read a video signal; the sound receiving component will read an audio signal; and the control circuit board will transmit the video signal and the audio signal to the mobile phone and the auxiliary machine through a network communication module. That is to say, a user can receive a visitor reminder and video and voice messages from the visitor on the mobile phone and the auxiliary machine. The user can perform a voice information interaction with the visitor through the mobile phone and the auxiliary machine. The doorbell host of the present disclosure is designed with perfect functions, while in the structure setting of the host, the front side faces are connected on two sides of the front face, and each front side face is provided with a light board. That is, the present disclosure is designed to have two rows, i.e. left and right rows of light boards, while there is an angle between the two rows of light boards, which has a large angle of irradiation range. The structure of components designed by the present disclosure is compact and reasonable and small in overall volume.

### BRIEF DESCRIPTION OF THE DRAWINGS

The present disclosure will be further described in detail below with reference to the accompanying drawings and the preferred embodiments, but it will be appreciated by those skilled in the art that these accompanying drawings are drawn only for the purpose of explaining the preferred embodiments, and thus they should not be construed as limiting the scope of the present disclosure. In addition, unless otherwise indicated, the accompanying drawings only indicate conceptual representations of the composition or structures of described objects, and may include exaggerated illustration, and the accompanying drawings are not necessarily drawn to scale.

FIG. 1 is a structural schematic diagram 1 of a host;

FIG. 2 is a structural schematic diagram 2 of a host; and

FIG. 3 is a structural schematic diagram of an auxiliary machine.

### DETAILED DESCRIPTION OF THE EMBODIMENTS

The present disclosure will be explained in detail below in conjunction with the accompanying drawings.

In order to make the objectives, technical solutions and advantages of the present disclosure more comprehensible, the present disclosure will be further described in detail below with reference to the accompanying drawings and embodiments. It should be understood that the specific embodiments described herein are only used to explain the present disclosure and not to limit it.

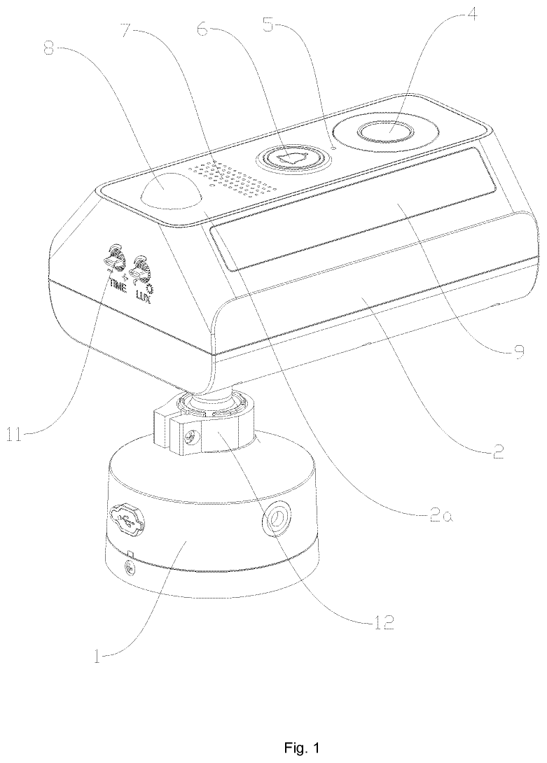

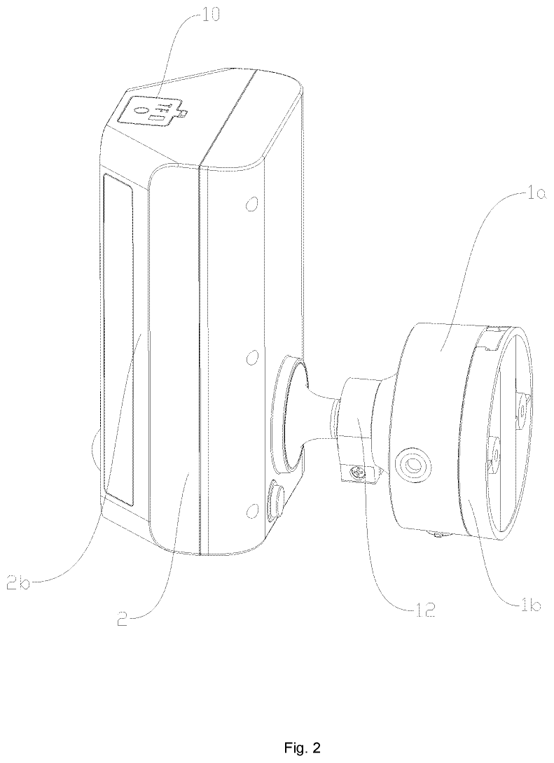

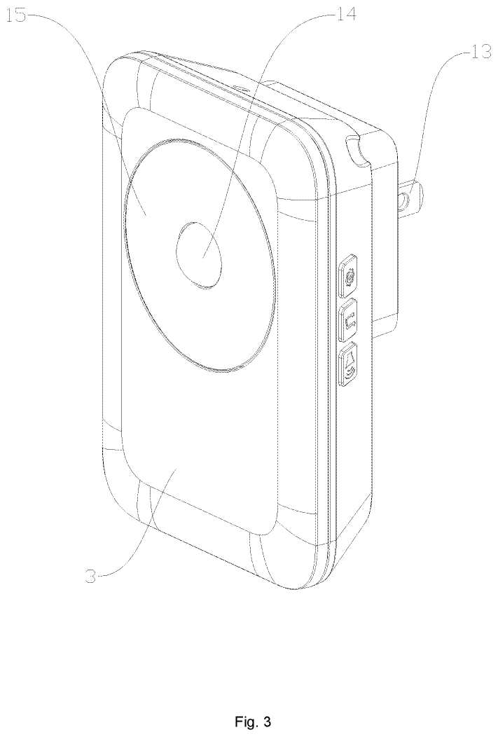

As shown in FIG. 1 to FIG. 3, an intelligent visual intercom doorbell camera light comprises a mounting base 1 installed outdoors, a host 2 with a built-in control circuit board, and an auxiliary machine 3 installed indoors. The host 2 includes a front face 2a and front side faces 2b connecting two side faces. The front side face 2b of the host 2 is trapezoidal in structure. The front face 2a is provided with a camera 4, a sound receiving hole 5, a doorbell button 6, a loudspeaker 7, and a human body sensor 8, connected with the control circuit board. The front side face 2b is provided with a light board 9. The control circuit board is provided therein with a network communication module capable of transmitting a signal to a mobile phone and the auxiliary machine 3.

The host 2 is provided at a top thereof with a notch 10 covered by a dust-proof plug. The notch 10 is provided therein with a memory card connected with the control circuit board. The control circuit board reads a video signal through the camera 4 and inputs the video signal into the memory card for storage; and the control circuit board reads an audio signal through a sound receiving component and inputs the audio signal into the memory card for storage.

The host 2 is provided at a bottom thereof with an adjusting knob component 11 connected with the control circuit board. The adjusting knob component 11 can adjust sensitivity of the human body sensor 8 and a light-emitting duration of the light board 9.

The camera 4, the sound receiving hole 5, the doorbell button 6, the loudspeaker 7, and the human body sensor 8 are arranged on the front face 2a of the host 2 in an order from top to bottom. The arrangement and reasonable layout of functional elements on the front face 2a of the host 2 enables the present disclosure has a beautiful and compact appearance.

The notch 10 is further provided therein with a reset button in communication with the memory card. The reset button can clean the storage information in the memory card.

The mounting base 1 is provided with a spherical notch. The host 2 is connected with the mounting base 1 through a spherical connector installed in the spherical notch. The spherical notch is surrounded from outside thereof by a locking piece 12 connecting a locking bolt. The present disclosure can achieve rotation adjustment of the host 2 portion from various angles in front relative to a wall on which the host 2 is mounted, so as to meet requirements in different environments.

The mounting base 1 comprises an outer seat 1a provided with a spherical notch and an inner seat 1b connecting a wall. The inner seat 1b and the outer seat 1a are connected through a sliding chute, the sliding chute being vertically set. The setting of the sliding chute can adjust the height of the host 2 to a certain extent.

The auxiliary machine 3 is provided therein with a control circuit auxiliary board. The auxiliary machine 3 is provided on a rear face thereof with a plug 13 connecting an insertable socket. The auxiliary machine 3 is provided therein with a ringing bell. When receiving a signal transmitted by the host 2, the auxiliary machine 3 will make a sound to remind the user.

The auxiliary machine 3 is provided at a front face thereof with an infrared sensor 14 and a plurality of LED lights 15 connected to the control circuit auxiliary board. The plurality of LED lights 15 regularly surrounds the infrared sensor 14 from outside. The auxiliary machine 3 is directly installed in the socket, and the infrared sensor and the LED lights are designed to simultaneously have the function of a small night light.

The control circuit auxiliary board is provided with a network communication module capable of receiving a signal.

In the description of the present disclosure, it should be noted that the orientation or position relationships indicated by the terms “center,” “top,” “bottom,” “left,” “right,” “vertical,” “horizontal,” “inner,” “outer” and the like are based on the orientation or position relationships shown in the accompanying drawings, and are intended only to facilitate the description of the present disclosure and to simplify the description, rather than to indicate or imply that the device or element referred to must have a specific orientation and be constructed and operated in a specific orientation, and thus cannot be construed as a limitation of the present disclosure. In addition, the terms “first,” “second” and “third” are used only for the purpose of description, and cannot be construed to indicate or imply a relative importance.

In the description of the present disclosure, it should be noted that unless explicitly stated and defined otherwise, the terms “installed,” “connected with” and “connecting” shall be understood in a broad sense, for example, the connection can be a fixed connection, a detachable connection or an integral connection, can be a mechanical connection or an electrical connection, can be a direct connection or an indirect connection through an intermediate medium, and can also be a communication inside two elements. For those of ordinary skill in the art, the specific meanings of the above-mentioned terms in the present disclosure can be understood based on specific situations.

The present disclosure has been described in detail above, and specific examples are used herein to clarify the principle and implementation mode of the present disclosure. The description of the above embodiments is only used to help understand the present disclosure and the core idea thereof. It should be noted that, for those of ordinary skill in the art, without departing from the principle of the present disclosure, some improvements and modifications can be made to the present disclosure, and these improvements and modifications also fall within the protection scope of the claims of the present disclosure.

1. An intelligent visual intercom doorbell camera light, comprising a mounting base installed outdoors, a host with a built-in control circuit board, and an auxiliary machine installed indoors, characterized in that the host is trapezoidal in structure, comprising a front face and front side faces connecting two side faces, the front face being provided with a camera, a sound receiving hole, a doorbell button, a loudspeaker, and a human body sensor, connected with the control circuit board, and each front side face being provided with a light board; and the control circuit board is provided therein with a network communication module capable of transmitting a signal to a mobile phone and the auxiliary machine.

2. The intelligent visual intercom doorbell camera light according to claim 1, characterized in that the host is provided at a top thereof with a notch covered by a dust-proof plug, the notch being provided therein with a memory card connected with the control circuit board; the control circuit board reads a video signal through the camera and inputs the video signal into the memory card for storage; and the control circuit board reads an audio signal through a sound receiving component and inputs the audio signal into the memory card for storage.

3. The intelligent visual intercom doorbell camera light according to claim 1, characterized in that the host is provided at a bottom thereof with an adjusting knob component connected with the control circuit board, the adjusting knob component being capable of adjusting sensitivity of the human body sensor and a light-emitting duration of the light board.

4. The intelligent visual intercom doorbell camera light according to claim 1, characterized in that the camera, the sound receiving hole, the doorbell button, the loudspeaker, and the human body sensor are arranged on the front face of the host in an order from top to bottom.

5. The intelligent visual intercom doorbell camera light according to claim 1, characterized in that the notch is further provided therein with a reset button in communication with the memory card.

6. The intelligent visual intercom doorbell camera light according to claim 1, characterized in that the mounting base is provided with a spherical notch; the host is connected with the mounting base through a spherical connector installed in the spherical notch, and the spherical notch is surrounded from outside thereof by a locking piece connecting a locking bolt.

7. The intelligent visual intercom doorbell camera light according to claim 6, characterized in that the mounting base comprises an outer seat provided with a spherical notch and an inner seat connecting a wall, the inner seat and the outer seat being connected through a vertically set sliding chute.

8. The intelligent visual intercom doorbell camera light according to claim 1, characterized in that the auxiliary machine is provided therein with a control circuit auxiliary board, is provided on a rear face thereof with a plug connecting an insertable socket, and is provided therein with a ringing bell.

9. The intelligent visual intercom doorbell camera light according to claim 8, characterized in that the auxiliary machine is provided at a front face thereof with an infrared sensor and a plurality of LED lights connected with the control circuit auxiliary board, the plurality of LED lights regularly surrounding the infrared sensor from outside.

10. The intelligent visual intercom doorbell camera light according to claim 8, characterized in that the control circuit auxiliary board is provided with a network communication module capable of receiving a signal.
